(19) United States
(12) Patent Application Publication
(10) Pub. No.: US 2015/0158199 A1
(43) Pub. Date: Jun. 11, 2015

(54) Tool Coupling Device

(71) Applicant: Robert Bosch GmbH, Stuttgart (DE)

(72) Inventors: Uwe Engelfried, Ostfildern (DE); Thomas Duerr, Asperg (DE); Jens Zieger, Altbach (DE); Petr Grulich, Kirchheim/Teck (DE)

(73) Assignee: Robert Bosch GmbH, Stuttgart (DE)

(21) Appl. No.: 14/411,411

(22) PCT Filed: Jun. 10, 2013
(86) PCT No.: PCT/EP2013/061868

§ 371 Date: Dec. 26, 2014

(30) Foreign Application Priority Data
Jun. 28, 2012 (JP) 10 2012 211 094.1

(51) Int. Cl. B27B 17/14; B27B 17/02

(52) U.S. Cl. CPC B27B 17/14; B27B 17/02

(57) ABSTRACT

A tool coupling device for a receptacle of a machine tool separating device formed as a closed system includes at least one cutting strand tensioning unit that has at least one tensioning element. The tool coupling device also includes at least one operating unit that includes at least one operating element. The cutting strand tensioning unit includes at least one gear unit that is configured to move the tensioning element as a result of an actuation of the operating element of the operating unit.

### PRIOR ART

There are already known tool coupling devices for receiving a power-tool parting device realized as a closed system, which has at least one cutting-strand tensioning unit that has at least one tensioning element, and which have at least one operating unit comprising at least one operating element.

### DISCLOSURE OF THE INVENTION

The invention is based on a tool coupling device, in particular a hand power-tool tool coupling device, for receiving a power-tool parting device realized as a closed system, having at least one cutting-strand tensioning unit that has at least one tensioning element, and having at least one operating unit comprising at least one operating element.

It is proposed that the cutting-strand tensioning unit comprise at least one transmission unit, which is provided to move the tensioning element as a result of an actuation of the operating element of the operating unit. The tensioning element is thus preferably connected to the operating element in a motionally dependent manner, via the transmission unit. “Provided” is to be understood to mean, in particular, specially programmed, designed and/or equipped. The tool coupling device is preferably provided to receive the power-tool parting device in a form-closed and/or force-closed manner, or to fix the power-tool parting device to a main body of the tool coupling device by means of a form-closed and/or by means of a force-closed connection. For the purpose of transmitting driving forces to the power-tool parting device, the power-tool parting device is preferably received by the tool coupling device, or fixed to the main body of the tool coupling device. Particularly preferably, the tool coupling device has at least one holding unit, which is provided to fix the power-tool parting device to the main body in at least one state. The holding unit preferably comprises at least one operating unit. The operating element in this case, at least in one state, preferably exerts a holding force upon the power-tool parting device, in particular in at least one state in which the power-tool parting device has been connected to the tool coupling device. The operating element preferably fixes the power-tool parting device to the main body of the tool coupling device by means of a form-closed and/or by means of a force-closed connection. It is also conceivable, however, for the holding unit to be of another design, considered appropriate by persons skilled in the art. Moreover, the holding unit preferably comprises at least one fixing unit, comprising at least one fixing element provided to fix the operating element in at least one position. Thus, for the purpose of receiving a power-tool parting device, realized as a closed system, the tool coupling device has at least the cutting-strand tensioning unit comprising at least the tensioning element, and has at least the holding unit comprising the operating unit, the cutting-strand tensioning unit comprising at least the transmission unit, which is provided to move the tensioning unit as a result of an actuation of the operating element of the holding unit comprising the operating unit.

The term “cutting-strand tensioning unit” is intended here to define, in particular, a unit provided to exert a tensioning force upon the cutting strand, for the purpose of tensioning, or pretensioning, a cutting strand of the power-tool parting device, at least in a state in which the power-tool parting device has been connected to the tool coupling device. The tensioning element in this case is preferably mounted on the main body of the tool coupling device so as to be movable relative to the main body of the tool coupling device. An “operating unit” is to be understood here to mean, in particular, a unit having at least the operating element, which can be actuated directly by an operator, and which is provided to influence and/or alter a process and/or a state of a unit coupled to the operating unit, through an actuation and/or through an input of parameters. The term “operating element” is intended to define, in particular, an element provided to pick up an input quantity from an operator in the case of an operating action, and in particular to be contacted directly by an operator, contacting of the operating element being sensed and/or an actuating force exerted upon the operating element being sensed and/or being transferred mechanically for the purpose of actuating a unit, in particular the transmission unit.

A “transmission unit” is to be understood here to mean, in particular, a mechanical mechanism by means of which at least one movement quantity of at least one component, such as, for example, a movement type (rotation, translation, etc.), a movement path, a movement speed and/or an acceleration can be altered. Preferably, the transmission unit is provided to step up and/or step down a force and/or a torque and/or to convert a movement type, such as, for example, conversion of a rotational movement of one component into a translational movement of another component. Particularly preferably, the transmission unit is provided for converting movement, or changing a movement type, between the operating element and the tensioning element. The transmission unit in this case may be realized as an eccentric mechanism, as a lever mechanism, as a cam mechanism, as a screw mechanism, etc. Advantageously, the design according to the invention makes it possible to achieve a tool coupling device that is easy to operate. Advantageously, by means of the cutting-strand tensioning unit, an automatic tensioning operation can be realized by actuation of the operating element.

Furthermore, it is proposed that the operating element be mounted such that it can be swiveled about an axis of motion of the operating element that is at least substantially parallel to a plane of main extent of the operating element. “Substantially parallel” is to be understood here to mean, in particular, an alignment of a direction relative to a reference direction, in particular in one plane, the direction deviating from the reference direction by, in particular, less than 8°, advantageously less than 5°, and particularly advantageously less than 2°. The term “plane of main extent” is intended here to define, in particular, a plane in which the operating element has a maximum extent. Preferably in this case, the operating element can be swiveled by a swivel angle that, in particular, is greater than 5°, preferably greater than 45°, and particularly preferably greater than 75°. Preferably, the plane of main extent of the operating element, in an operating element swiveled fully into an open position, is at least substantially parallel to a rotation axis of a drive element that is mounted in a rotatable manner in the main body of the tool coupling device. Preferably in this case, the axis of motion of the operating element is at least substantially perpendicular to a rotation axis of a drive element of the tool coupling device, or of a portable power tool comprising the tool coupling device, that is mounted in a rotatable manner in the main body of the tool coupling device. The expression “substantially perpendicular” is intended here to define, in particular, an alignment of a direction relative to a reference direction, wherein the direction and the relative direction, in particular as viewed in one plane, enclose an angle of 90° and the angle has a maximum deviation of, in particular, less than 8°, advantageously less than 5°, and particularly advantageously less than 2°. Advantageously, a lever principle may be used to generate a tensioning force. Thus, advantageously, the tool coupling device according to the invention can be made easy to operate, with only a small amount of force being required, advantageously, to move the operating element, or the tensioning element.

In an alternative design of the tool coupling device according to the invention, it is proposed that the operating element be mounted such that it can rotate about an axis of motion of the operating element that is at least substantially perpendicular to a plane of main extent of the operating element. Preferably, the plane of main extent of the operating element is at least substantially perpendicular to the rotation axis of the drive element. Advantageously, the design according to the invention makes it possible to achieve a compact tool coupling device.

It is additionally proposed that the tensioning element be mounted in a translationally movable manner. The expression “mounted in a translationally movable manner” is intended here to define, in particular, a mounting of a unit and/or of an element relative to at least one other unit and/or one other element, the unit and/or the element, in particular dissociated from an elastic deformation of the unit and/or element, and dissociated from movement capabilities caused by a bearing clearance, having a capability to move along at least one axis, along a distance greater than 1 mm, preferably greater than 5 mm, and particularly preferably greater than 10 mm. Advantageously, the design according to the invention makes it possible to achieve a compact tool coupling device.

It is additionally proposed that the transmission unit have at least one gate element for moving the tensioning element as a result of an actuation of the operating element. A “gate element” is to be understood here to mean, in particular, an element having at least one recess, in particular a slot, in which there engages a further element that corresponds to the element, and/or which has at least one extension that engages in a recess of a further element that corresponds to the element, a constrained movement of the further element being effected, in dependence on a geometric shape of the recess, as a result of a movement of the element. Preferably, the gate element is realized as a gate disk or as a gate translation element. Preferably, the tensioning element engages in the recess of the gate element. Through simple design means, it is possible to achieve movement of the tensioning element on a predefined movement path. Thus, advantageously, the travel distance along which the tensioning element moves can be limited through simple design means.

Furthermore, it is proposed that the gate element be mounted in a translationally movable manner. Preferably, the gate element has an axis of motion that is at least substantially perpendicular to the rotation axis of the drive element. Preferably, the gate element is guided translationally by two linear guide elements of the transmission unit that are at least substantially parallel to each other. Advantageously, the design of the tool coupling device according to the invention enables the gate element to be guided in a precise manner.

Moreover, in an alternative design of the tool coupling device, it is proposed that the gate element be mounted in a rotatable manner. Preferably, the gate element has an axis of motion that is at least substantially parallel to the rotation axis of the drive element. Advantageously, it is possible to achieve a transmission unit designed to have a flat structure. Thus, advantageously, a compact tool coupling device can be achieved.

It is additionally proposed that the cutting-strand tensioning unit have at least one spring element, which is provided to apply a spring force to the tensioning element and/or to a gate element of the transmission unit. A “spring element” is to be understood to mean, in particular, a macroscopic element having at least two ends that are spaced apart from each other and that, in a normal operating state, can be moved elastically relative to each other along a movement path, the movement path being at least greater than 0.5 mm, in particular greater than 1 mm, preferably greater than 2 mm, and particularly advantageously greater than 3 mm, and that, in particular, generates a counter-force, which is dependent on an elastic movement of the ends relative to each other and preferably proportional to the elastic movement of the ends relative to each other, and which counteracts the variation. A “macroscopic element” is to be understood to mean, in particular, an element having an extent of at least 1 mm, in particular of at least 5 mm, and preferably of at least 10 mm. The spring element in this case may be realized as a tension spring, as a compression spring, as a torsion spring, as a spiral spring, etc. Particularly preferably, the spring element is realized as a helical compression spring or as a leg spring. It is also conceivable, however, for the spring element to be of different design, considered appropriate by persons skilled in the art. Advantageously, the design of the tool coupling device according to the invention enables the tensioning element to be biased to at least one operating position, in particular to a tensioning position.

Furthermore, it is proposed that the transmission unit comprise at least one lever element that, as a result of an actuation of the operating element, moves a gate element of the transmission unit for the purpose of moving the tensioning element. A “lever element” is to be understood here to mean, in particular, an element mounted such that it can be swiveled at least about an axis of motion of the element and that, in particular, has a maximum extent along a direction that is at least substantially perpendicular to the axis of motion, in order to realize at least one lever arm. Preferably, the lever element is realized as a two-sided lever element that, as viewed in two opposing directions, out from the axis, or from a rotation point, realizes a load arm and a power arm, respectively. It is conceivable for the transmission unit to have a multiplicity of lever elements that act in combination with each other, or are connected to each other, for the purpose of moving the tensioning element. Advantageously, by means of the design according to the invention, a stepped-up force can be produced for the purpose of moving the tensioning element. Thus, advantageously, a small actuating force, applied by an operator to actuate the operating element, can be stepped up to a large actuating force of the tensioning element.

It is additionally proposed that the transmission unit have at least one eccentric element that acts in combination with the tensioning element for the purpose of moving the tensioning element as a result of an actuation of the operating element. An “eccentric element” is to be understood here to mean, in particular, an element mounted such that it can be swiveled at least about an axis of motion of the element, a mid-point, in particular a symmetry mid-point, of the element being disposed outside of the axis of motion. The eccentric element in this case may be directly or indirectly coupled to the tensioning element. Advantageously, a movement of the operating element can be converted to a movement of the tensioning element.

It is additionally proposed that the tool coupling device have at least one fixing unit, comprising at least one fixing element provided to fix the operating element in at least one position. Preferably, the fixing element is mounted in a rotatable manner. It is also conceivable, however, for the fixing element to be mounted in a translationally movable manner. Advantageously, by means of the design according to the invention, unintentional movement of the operating element can be prevented.

The invention is additionally based on a portable power tool comprising a tool coupling device according to the invention. The tool coupling device is preferably provided for form-closed and/or force-closed coupling to a power-tool parting device. A “portable power tool” is to be understood here to mean, in particular, a power tool, in particular a hand power tool, that can be transported by an operator without the use of a transport machine. The portable power tool has, in particular, a mass of less than 40 kg, preferably less than 10 kg, and particularly preferably less than 5 kg. Advantageously, it is possible to achieve a portable power tool on which a power-tool parting device can be arranged in a particularly convenient manner.

The invention is additionally based on a power tool system comprising a power tool according to the invention, and comprising a power-tool parting device, which has at least one cutting strand and has at least one guide unit that, together with the cutting strand, forms a closed system. A “cutting strand” is to be understood here to mean, in particular, a unit provided to locally undo an atomic coherence of a workpiece on which work is to be performed, in particular by means of a mechanical parting-off and/or by means of a mechanical removal of material particles of the workpiece. Preferably, the cutting strand is provided to separate the workpiece into at least two parts that are physically separate from each other, and/or to part off and/or remove, at least partially, material particles of the workpiece, starting from a surface of the workpiece. The cutting strand is preferably realized as a cutting chain. It is also conceivable, however, for the cutting strand to be of another design, considered appropriate by persons skilled in the art, such as, for example, designed as a cutting cord, to which cutting elements are fixed. The expression “guide unit” is intended here to define, in particular, a unit provided to exert a constraining force upon the cutting strand, at least along a direction perpendicular to a cutting direction of the cutting strand, in order to define a movement capability of the cutting strand along the cutting direction. A “cutting direction” is to be understood here to mean, in particular, a direction along which the cutting strand is moved, in at least one operating state, as a result of a driving force and/or a driving torque, in particular in the guide unit, for the purpose of producing a cut and/or parting-off and/or removing material particles of a workpiece on which work is to be performed. Preferably, the cutting strand, when in an operating state, is moved, relative to the guide unit, along the cutting direction. The term “closed system” is intended here to define, in particular, a system comprising at least two components that, by means of combined action, when the system has been demounted from a system, in particular the tool coupling device, that is of a higher order than the system, maintain a functionality and/or are inseparably connected to each other when in the demounted state. Preferably, the at least two components of the closed system are connected to each other so as to be at least substantially inseparable by an operator. “At least substantially inseparable” is to be understood here to mean, in particular, a connection of at least two components that can be separated from each other only with the aid of parting tools such as, for example, a saw, in particular a mechanical saw, etc. and/or chemical parting means such as, for example, solvents, etc.

In particular, the power-tool parting device, as viewed along a direction that is at least substantially perpendicular to a cutting plane of the power-tool parting device, has a maximum dimension of less than 10 mm, preferably less than 8 mm, and particularly preferably less than 5 mm. Preferably, the dimension is realized as the width of the power-tool parting device. Particularly preferably, the power-tool parting device, as viewed along the direction that is at least substantially perpendicular to the cutting plane of the power-tool parting device, has a maximum dimension that is at least substantially constant along a total length of the power-tool parting device. The power-tool parting device is thus preferably provided to produce a cut that has a maximum dimension of less than 5 mm, as viewed along the direction that is at least substantially perpendicular to the cutting plane of the power-tool parting device. The design according to the invention makes it possible, advantageously, to achieve a power tool system that can be adapted in a particularly convenient manner to differing fields of application in that, advantageously, the power-tool parting device can be removed from the tool coupling device.

The tool coupling device according to the invention, the portable power tool according to the invention and/or the power tool system according to the invention is/are not intended in this case to be limited to the application and embodiment described above. In particular, the tool coupling device according to the invention, the portable power tool according to the invention and/or the power tool system according to the invention may have individual elements, components and units that differ in number from the number stated herein, in order to fulfill a principle of function described herein.

### DRAWING

Further advantages are given by the following description of the drawing. The drawing shows exemplary embodiments of the invention. The drawing, the description and the claims contain numerous features in combination. Persons skilled in the art will also expediently consider the features individually and combine them to create appropriate further combinations.

There are shown in the drawing:

FIG. 1 a portable power tool according to the invention, having a tool coupling device according to the invention, in a schematic representation,

FIG. 2 a detail view of the tool coupling device according to the invention, in a schematic representation,

FIG. 3 a sectional view of the tool coupling device according to the invention, in a schematic representation,

FIG. 4 a detail view of a carrier element of a cutting-strand tensioning unit of the tool coupling device according to the invention, in a schematic representation,

FIG. 5 a side view of the tool coupling device according to the invention, with a power-tool parting device disposed in the tool coupling device according to the invention, in a schematic representation,

FIG. 6 a further side view of the tool coupling device according to the invention, with the power-tool parting device disposed in the tool coupling device according to the invention, in a schematic representation,

FIG. 7 a detail view of an alternative tool coupling device according to the invention, in a schematic representation,

FIG. 8 a sectional view of the alternative tool coupling device according to the invention, in a schematic representation,

FIG. 9 an exploded view of the alternative tool coupling device according to the invention, in a schematic representation,

FIG. 10 a detail view of a further, alternative tool coupling device according to the invention, in a schematic representation,

FIG. 11 a further detail view of the further, alternative tool coupling device according to the invention, in a schematic representation,

FIG. 12 a sectional view of the further, alternative tool coupling device according to the invention, in a schematic representation,

FIG. 13 a detail view of a further, alternative tool coupling device according to the invention, in a schematic representation,

FIG. 14 a sectional view of the further, alternative tool coupling device according to the invention from FIG. 13, in a schematic representation,

FIG. 15 a detail view of a further, alternative tool coupling device according to the invention, in a schematic representation,

FIG. 16 a further detail view of the further, alternative tool coupling device according to the invention from FIG. 15, in a schematic representation,

FIG. 17 a detail view of a further, alternative tool coupling device according to the invention, in a schematic representation,

FIG. 18 a further detail view of the further, alternative tool coupling device according to the invention from FIG. 17, in a schematic representation,

FIG. 19 a detail view of a further, alternative tool coupling device according to the invention, in a schematic representation,

FIG. 20 a further detail view of the further, alternative tool coupling device according to the invention from FIG. 19, in a schematic representation,

FIG. 21 a sectional view of the further, alternative tool coupling device according to the invention from FIG. 19, in a schematic representation,

FIG. 22 a detail view of an alternative design of a power-tool parting-device hold-down unit, in a schematic representation,

FIG. 23 a detail view of a further, alternative design of a power-tool parting-device hold-down unit, in a schematic representation,

FIG. 24 a detail view of a further, alternative design of a power-tool parting-device hold-down unit, in a schematic representation,

FIG. 25 a detail view of a further, alternative design of a power-tool parting-device hold-down unit, in a schematic representation,

FIG. 26 a detail view of a further, alternative design of a power-tool parting-device hold-down unit, in a schematic representation,

FIG. 26 a detail view of a further, alternative design of a power-tool parting-device hold-down unit, in a schematic representation,

FIG. 28 a detail view of a further, alternative design of a power-tool parting-device hold-down unit, in a schematic representation,

FIG. 29 a detail view of a further, alternative design of a power-tool parting-device hold-down unit, in a schematic representation,

FIG. 30 a detail view of a further, alternative design of a power-tool parting-device hold-down unit, in a schematic representation,

FIG. 31 a detail view of a further, alternative design of a power-tool parting-device hold-down unit, in a schematic representation,

FIG. 32 a detail view of an alternative design of a power-tool parting-device torque holding unit, in a schematic representation,

FIG. 33 a detail view of a further, alternative design of a power-tool parting-device torque holding unit, in a schematic representation,

FIG. 34 a detail view of a further, alternative design of a power-tool parting-device torque holding unit, in a schematic representation, and

FIG. 35 a detail view of a further, alternative design of a power-tool parting-device torque holding unit, in a schematic representation.

### DESCRIPTION OF THE EXEMPLARY EMBODIMENTS

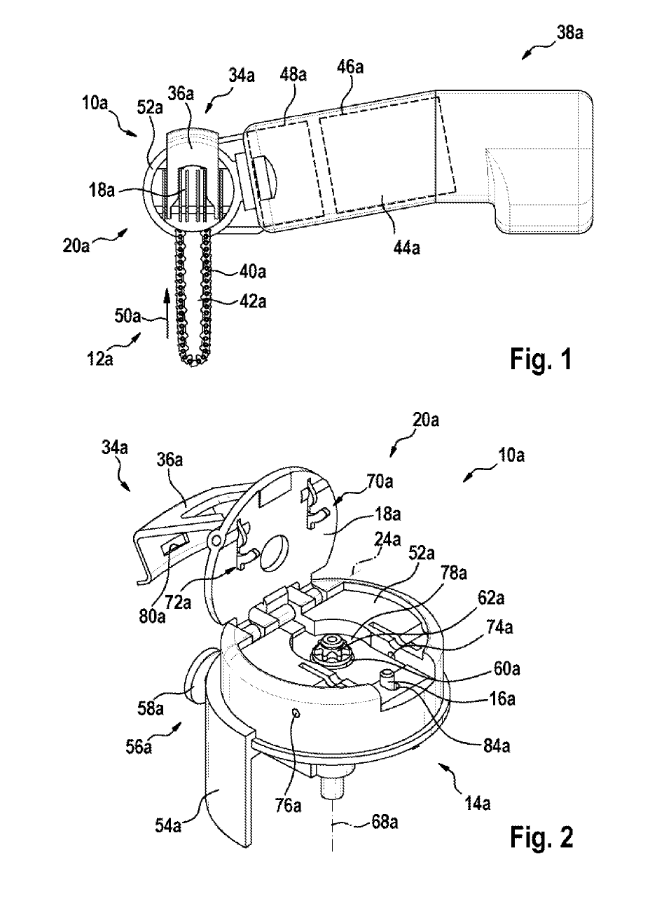

FIG. 1 shows a portable power tool 38a, having a power-tool parting device 12a disposed on a tool coupling device 10a of the portable power tool 38a. The portable power tool 38a and the power-tool parting device 12a together form a power tool system. The power-tool parting device 12a comprises at least one cutting strand 40a, and at least one guide unit 42a for guiding the cutting strand 40a. The guide unit 42a and the cutting strand 40a together form a closed system. The power-tool parting device 12a is thus realized as a closed system. The portable power tool 38a has the tool coupling device 10a for coupling the power-tool parting device 12a in a form-closed and/or force-closed manner. The tool coupling device 10a is provided to receive the power-tool parting device 12a realized as a closed system. The tool coupling device 10a in this case comprises at least one cutting-strand tensioning unit 14a, which has at least one tensioning element 16a, and which has at least one operating unit 20a comprising at least one operating element 18a. Moreover, the portable power tool 38a has a power-tool housing 44a, which encloses a drive unit 46a and an output transmission unit 48a of the portable power tool 38a. The drive unit 46a and the output transmission unit 48a are operatively connected to each other, in a manner already known to persons skilled in the art, for the purpose of generating a drive torque that can be transmitted to the power-tool parting device 12a. The output transmission unit 48a is realized as a bevel gear transmission. The drive unit 46a is realized as an electric motor unit. It is also conceivable, however, for the drive unit 46a and/or the output transmission unit 48a to be of a different design, considered appropriate by persons skilled in the art, such as, for example, the drive unit 46a being designed as a hybrid drive unit or as an internal combustion drive unit, etc., and/or the output transmission unit 48a being designed as a worm gear transmission, etc. The drive unit 46a is provided to drive the cutting strand 40a of the power-tool parting device 12a, in at least one operating state, via the output transmission unit 48a. The cutting strand 40a in this case is moved in the guide unit 42a of the power-tool parting device 12a, along a cutting direction 50a of the cutting strand 40a, relative to the guide unit 42a.

FIG. 2 shows the tool coupling device 10a demounted from the portable power tool 38a. The tool coupling device 10a comprises a main body 52a, which is mounted in a rotatable manner in a connection housing 54a of the tool coupling device 10a. The main body 52a in this case is mounted in the connection housing 54a so as to be rotatable about a rotation axis 68a of a drive element 62a of the tool coupling device 10a. When the tool coupling device 10a is mounted on the portable power tool 38a, the connection housing 54a is fixed to the power-tool housing 44a of the portable power tool 38a. The tool coupling device 10a has at least one rotary positioning unit 56a, for fixing a rotary position of the main body 52a relative to the connection housing 54a. The rotary positioning unit 56a in this case comprises at least one positioning element 58a, for fixing the main body 52a in a position relative to the connection housing 54a. The positioning element 58a in this case is realized as a spring-biased locking pin, which acts in combination with positioning recesses (not represented in greater detail here) of the main body 52a, in a manner already known to persons skilled in the art. It is also conceivable, however, for the rotary positioning unit 56a to be of a different design, considered appropriate by persons skilled in the art, such as, for example, designed as tooth system.

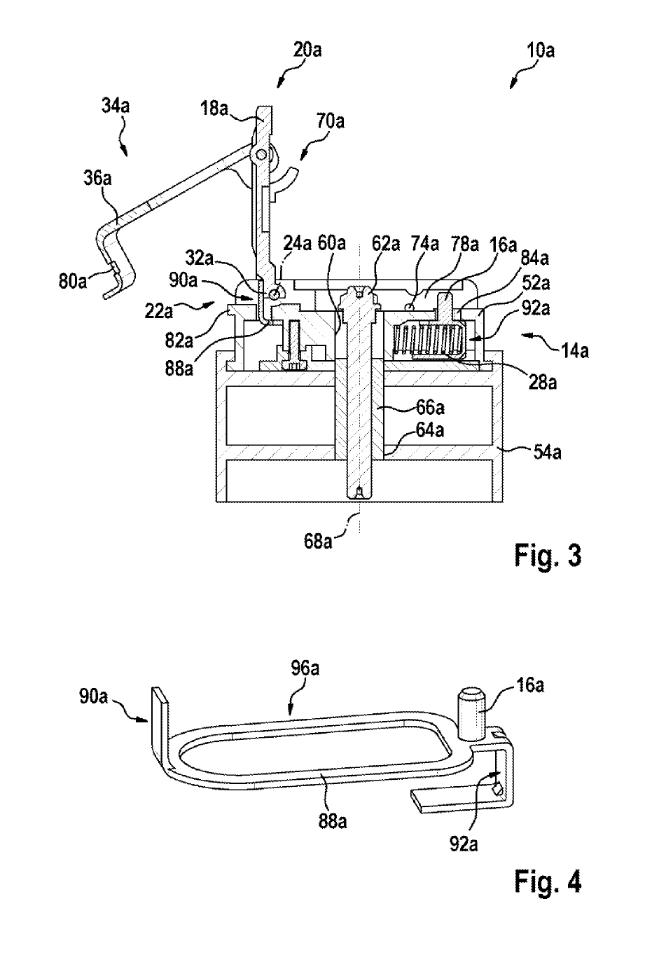

The main body 52a additionally has a rotary play opening 60a (FIG. 3), in which the drive element 62a of the tool coupling device 10a is disposed. In this case, the drive element 62a, as viewed along a direction that is at least substantially perpendicular to the rotation axis 68a of the drive element 62a, is disposed, relative to the main body 52a, at a distance from an edge region of the main body 52a that delimits the rotary play opening 60a. The drive element 62a is realized as a driving toothed wheel. The connection housing 54a comprises a bearing recess 64a, in which there is disposed a bearing element 66a of the tool coupling device 10a, for rotatably mounting the drive element 62a. The bearing element 66a is realized as a bearing sleeve. It is also conceivable, however, for the bearing element 66a to be realized as a rolling bearing. The drive element 62a is provided to transmit a driving force of the drive unit 46a to the cutting strand 40a. Thus, when the power-tool parting device 12a is connected to the tool coupling device 10a, the drive element 62a engages in the cutting strand 40a. In addition, when the tool coupling device 10a is mounted on the portable power tool 38a, the drive element 62a is connected to an output element (not represented in greater detail here) of the output transmission unit 48a in a rotationally fixed manner.

Furthermore, the operating element 18a of the operating unit 20a of the tool coupling device 10a is mounted such that it can swivel about an axis of motion 24a of the operating element 18a that is at least substantially parallel to a plane of main extent of the operating element 18a. The operating element 18a in this case is mounted in a swiveling manner on the main body 52a. The axis of motion 24a of the operating element 18a, as viewed in a plane of projection into which the axis of motion 24a and the rotation axis 68a of the drive element 62a are projected, is at least substantially perpendicular to the rotation axis 68a. The operating element 18a is mounted such that it can swivel by 90° relative to the main body 52a. It is also conceivable, however, for the operating element 18a to be mounted such that it can swivel by an angle other than 90° relative to the main body 52a.

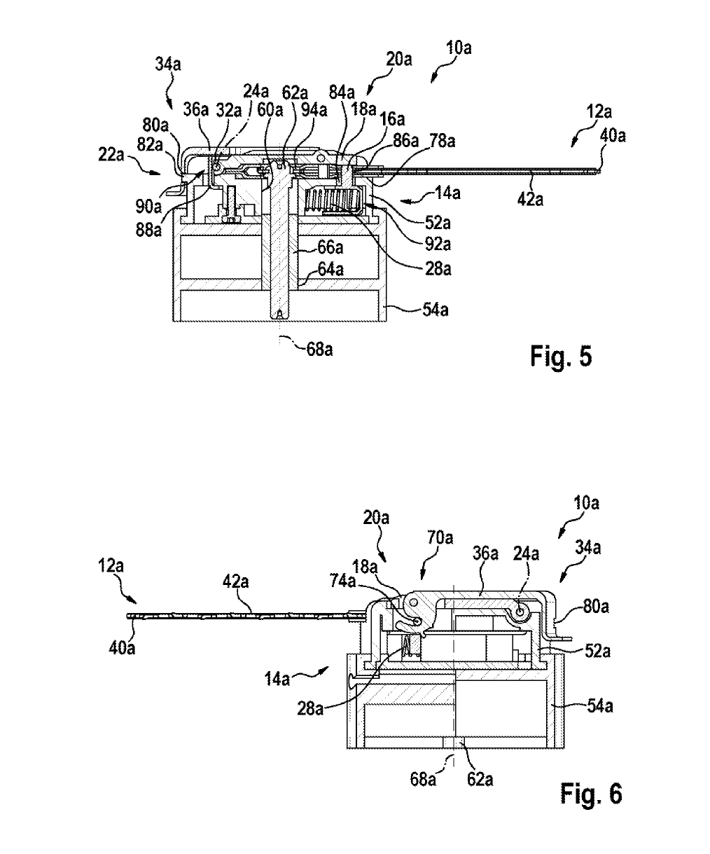

The tool coupling device 10a additionally has at least one fixing unit 34a, comprising at least one fixing element 36a provided to fix the operating element 18a in at least one position. The fixing element 36a is provided to fix the operating element 18a in a tool fixing position of the operating element 18a. For this purpose, the fixing element 36a is mounted in a swiveling manner. The fixing element 36a in this case is mounted in a swiveling manner on the operating element 18a. The fixing element 36a comprises at least two latching regions 70a, 72a. It is also conceivable, however, for the fixing element 36a to have a number of latching regions 70a, 72a other than two. The latching regions 70a, 72a, as viewed in a plane that is at least substantially perpendicular to the plane of main extent of the operating element 18a, or as viewed in a plane that is at least substantially parallel to the rotation axis 68a of the drive element 62a, are arcuate in form and each delimit an arcuate latching recess. Moreover, in an operating-element fixing position, the latching regions 70a, 72a act in combination with fixing studs 74a, 76a of the fixing unit 34a (FIG. 6). The fixing studs 74a, 76a are fixed to the main body 52a. The fixing unit 34a is thus provided to fix the operating element 18a in the tool fixing position by means of a form-closed connection. For the purpose of securing the fixing element 36a in the operating-element fixing position, the fixing element 36a additionally has a securing recess 80a, which acts in combination with a latching extension 82a of the fixing unit 34a when the fixing element 36a is in the operating-element fixing position (FIG. 5). The latching extension 82a in this case is integrally formed onto the main body 52a. It is also conceivable, however, for the latching extension 82a to be realized such that it is separate from the main body 52a, and to be fastened to the main body 52a by means of a fastening element considered appropriate by persons skilled in the art.

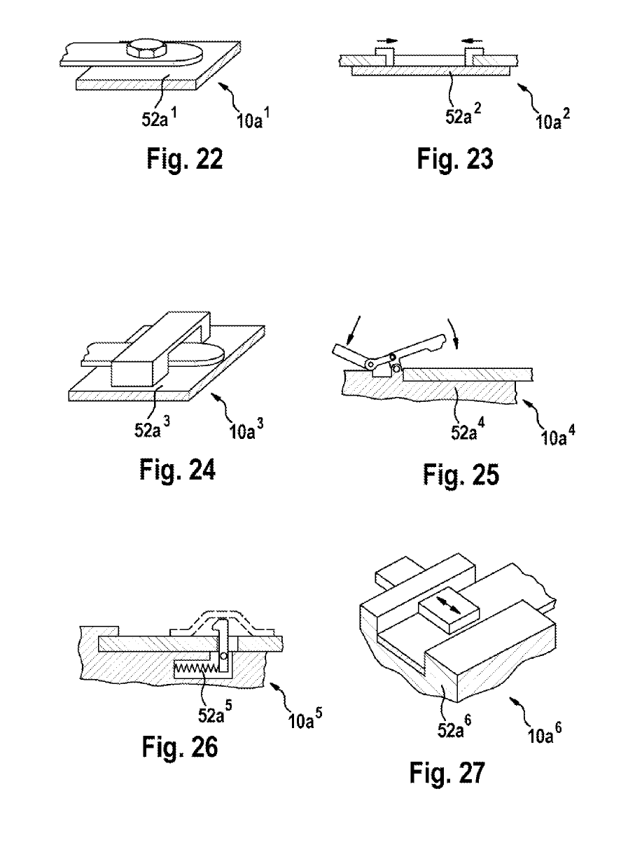

When the power-tool parting device 12a is coupled to the tool coupling device 10a, the power-tool parting device 12a, in the tool fixing position, is subjected to a clamping force in the direction of the main body 52a by means of the operating element 18a, in a receiving recess 78a of the main body 52a. This clamping force is generated by means of a swivel movement of the operating element 18a in the direction of the receiving recess 78a and by means of a combined action of the fixing element 36a and the fixing studs 74a, 76a when the operating element 18a is in the tool fixing position. Thus, at least the operating unit 20a and the fixing unit 34a, by acting in combination with the main body 52a, constitute a holding unit of the tool coupling device 10a. The holding unit is provided to act upon the power-tool parting device 12a, when the power-tool parting device 12a is coupled to the tool coupling device 10a, in a direction that is at least substantially parallel to the rotation axis 68a of the drive element 62a. It is also conceivable, however, for the holding unit to be of a different design, considered appropriate by persons skilled in the art (FIGS. 22 to 31).

Moreover, when the power-tool parting device 12a is coupled to the tool coupling device 10a, the power-tool parting device 12a is secured in a form-closed manner, by means of the receiving recess 78a of the main body 52a, against a rotational movement along a direction of rotation about the rotation axis 68a of the drive element 62a. The receiving recess 78a thus constitutes at least one power-tool parting-device torque holding element of a power-tool parting-device torque holding unit. For this purpose, the receiving recess 78a has a shape that corresponds to an external shape of at least one partial region of the power-tool parting device 12a, in particular a partial region of the guide unit 42a. The receiving recess 78a is thus realized as a negative shape of at least one partial region of the power-tool parting device 12a, in particular a partial region of the guide unit 42a. It is also conceivable, however, for the main body 52a to be of another design, considered appropriate by persons skilled in the art, that can prevent, insofar as possible, a rotational movement of the power-tool parting device 12a when the power-tool parting device 12a is coupled to the tool coupling device 10a (FIGS. 32 to 35).

Furthermore, the cutting-strand tensioning unit 14a comprises at least one transmission unit 22a, which is provided to move the tensioning element 16a as a result of an actuation of the operating element 18a of the operating unit 20a. The tensioning element 16a in this case is mounted in a translationally movable manner in a guide recess 84a of the main body 52a. The guide recess 84a is disposed in the receiving recess 78a. The tensioning element 16a is realized as a tensioning stud, which engages in a tensioning recess 86a (FIG. 5) of the power-tool parting device 12a when the power-tool parting device 12a is coupled to the tool coupling device 10a. The tensioning element 16a is realized so as to be integral with a carrier element 88a of the cutting-strand tensioning unit 14a. The carrier element 88a is mounted in a translationally movable manner in the main body 52a. In addition, the carrier element 88a comprises an actuating region 90a, which acts in combination with a transmission element of the transmission unit 22a for the purpose of moving the tensioning element 16a as a result of an actuation of the operating element 18a. The transmission element of the transmission unit 22a in this case is realized as an eccentric element 32a (FIG. 3). The transmission unit 22a thus comprises at least the eccentric element 32a, which acts in combination with the tensioning element 16a for the purpose of moving the tensioning element 16a as a result of an actuation of the operating element 18a, via the carrier element 88a. The eccentric element 32a is realized so as to be integral with the operating element 18a (FIG. 3). The eccentric element 32a is disposed on the operating element 18a, eccentrically, or asymmetrically, in relation to the axis of motion 24a of the operating element 18a.

Moreover, the cutting-strand tensioning unit 14a has at least one spring element 28a, which is provided to apply a spring force to the tensioning element 16a. The spring element 28a in this case is supported with one end on the main body 52a and, with another end, the spring element 28a is supported on a tensioning force support region 92a of the carrier element 88a. It is additionally conceivable that, for the purpose of supporting a tensioning force of the tensioning element 16a, the carrier element 88a an additional clamping and/or locking of the carrier element 88a on the main body 52a is possible, such as, for example, by a rough surface of the carrier element 88a or by a carrier element locking unit, etc. The tensioning force support region 92a and the actuating region 90a of the carrier element 88a in this case are connected to each other via a connecting region 96a of the carrier element 88a. The connecting region 96a has an elliptical shape (FIG. 4). When the operating element 18a is in a position in which it has been swiveled away from the main body 52a, the spring element 28a is compressed as a result of a combined action of the eccentric element 32a and the actuating region 90a of the carrier element 88a. As a result, the tensioning element 16a is moved into a guide-unit insertion position.

For the purpose of coupling the power-tool parting device 12a to the tool coupling device 10a, the power-tool parting device 12a is inserted in the receiving recess 78a of the main body 52a, along a direction that is at least substantially parallel to the rotation axis 68a of the drive element 62a. The operating element 18a in this case is disposed in the position in which it has been swiveled away from the main body 52a. As the power-tool parting device 12a is inserted in the receiving recess 78a, the drive element 62a is introduced into a coupling recess 94a of the guide unit 42a (FIG. 5). As a result, the cutting strand 40a engages with the drive element 62a. In addition, the tensioning element 16a is introduced into the tensioning recess 86a of the guide unit 42a. As a result of the operating element 18a being moved into the tool fixing position, the eccentric element 32a releases the actuating region 90a of the carrier element 88a. The carrier element 88a, together with the tensioning element 16a, is thus moved by a spring force of the spring element 28a, translationally in a direction away from the drive element 62a, into a tensioning position of the tensioning element 16a. As a result, the guide unit 42a is moved relative to the drive element 62a. This causes the cutting strand 40a to be tensioned by the spring force of the spring element 28a, or by the movement of the tensioning element 16a. Thus, automatic tensioning of the cutting strand 40a is effected as a result of the power-tool parting device 12a being clamped in the receiving recess 78a of the main body 52a. Moreover, the fixing of the operating element 18a by means of the fixing unit 34a results in self-locking of the cutting-strand tensioning unit 14a, in order to avoid unwanted removal of a tensioning force for tensioning the cutting strand 40a.

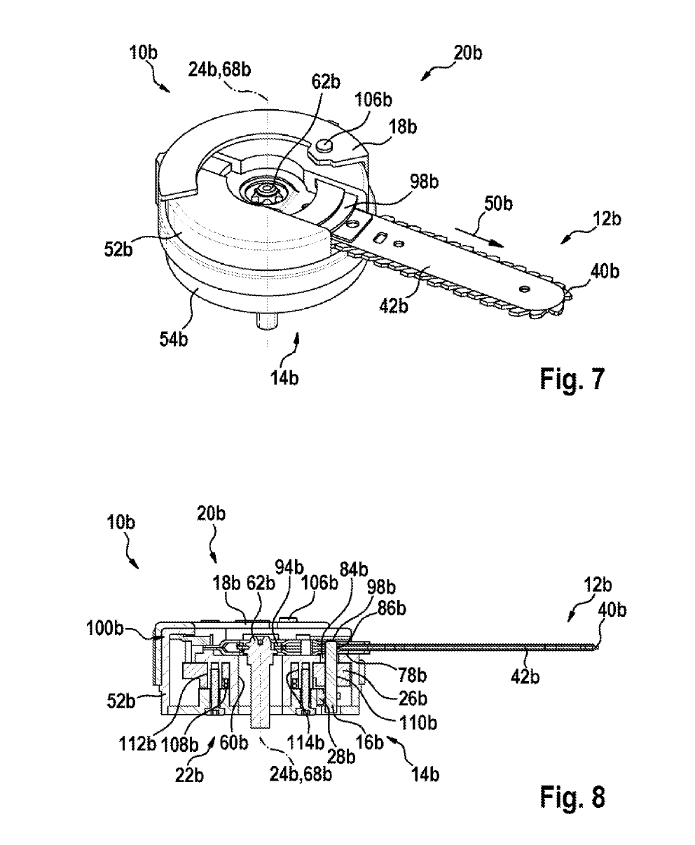

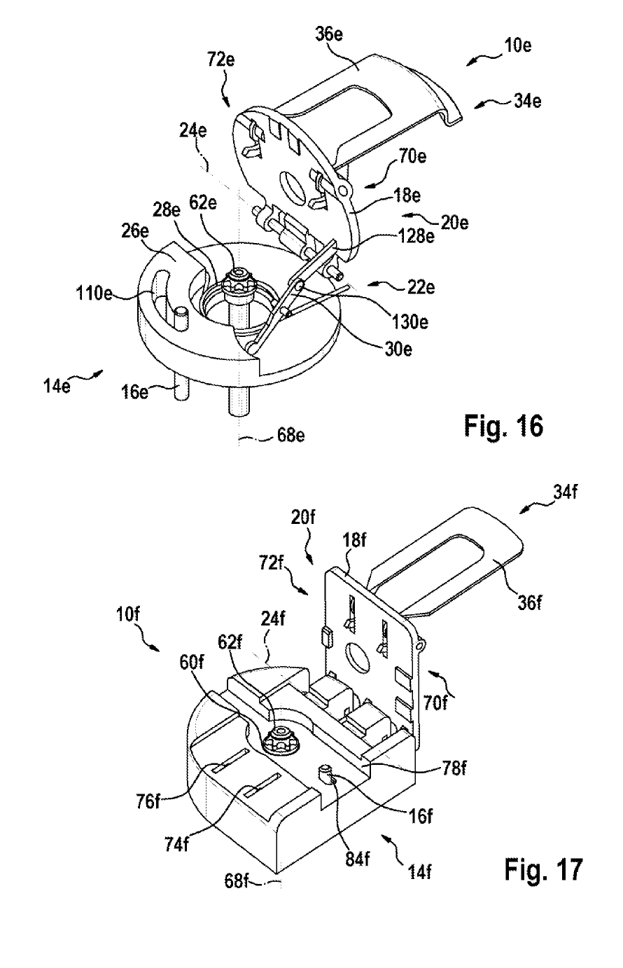

Alternative exemplary embodiments are represented in FIGS. 7 to 35. Components, features and functions that remain substantially the same are denoted basically by the same references. To differentiate the exemplary embodiments, the letters a to g, or superscript numerals, have been appended to the references of the exemplary embodiments. The following description is limited substantially to the differences as compared with the first exemplary embodiment described in FIGS. 1 to 6, and reference may be made to the description of the first exemplary embodiment in FIGS. 1 to 6 in respect of components, features and functions that remain the same.

FIG. 7 shows an alternative tool coupling device 10b, which is provided to receive a power-tool parting device 12b realized as a closed system, demounted from a portable power tool (not represented in greater detail here). The portable power tool is of a design similar to that of the portable power tool 38a described in FIGS. 1 to 6. The portable power tool and the power-tool parting device 12b together form a power tool system. The tool coupling device 10b has at least one cutting-strand tensioning unit 14b, which comprises at least one tensioning element 16b, and at least one operating unit 20b that comprises at least one operating element 18b. The operating element 18b in this case is mounted so as to be rotatable about an axis of motion 24b of the operating element 18b that is at least substantially perpendicular to a plane of main extent of the operating element 18b, or about one that is at least substantially parallel to a rotation axis 68b of a drive element 62b of the tool coupling device 10b. Moreover, the operating unit 20b comprises at least one clamping element 98b, which is provided to apply a clamping force to the power-tool parting device 12b, in the direction of a main body 52b of the tool coupling device 10b, when the operating element 18b is in a tool fixing position. The clamping element 98b is realized in the form of a circular-ring segment. In addition, the clamping element 98b is mounted in a rotatable manner in the main body 52b. For the purpose of generating a clamping force, the clamping element 98b has a tensioning region 100b in the shape of a spiral, or in the shape of a screw thread. The tensioning region 100b is disposed on an outer circumference of the clamping element 98b. It is also conceivable, however, for the tensioning region 100b to be disposed at another position on the clamping element 98b, considered appropriate by persons skilled in the art, such as, for example, on an inner circumference of the clamping element 98b. The tensioning region 100b has a slope, as viewed along a circumferential direction extending around the rotation axis 68b of the drive element 62b. Along a total extent of the tensioning region 100b, therefore, the tensioning region 100b is sloped relative to a plane of main extent of the clamping element 98b. The tensioning region 100b, for the purpose of generating a clamping force, acts in combination with a tensioning slot (not represented in greater detail here) of the main body 52b, in which the tensioning region 100b engages.

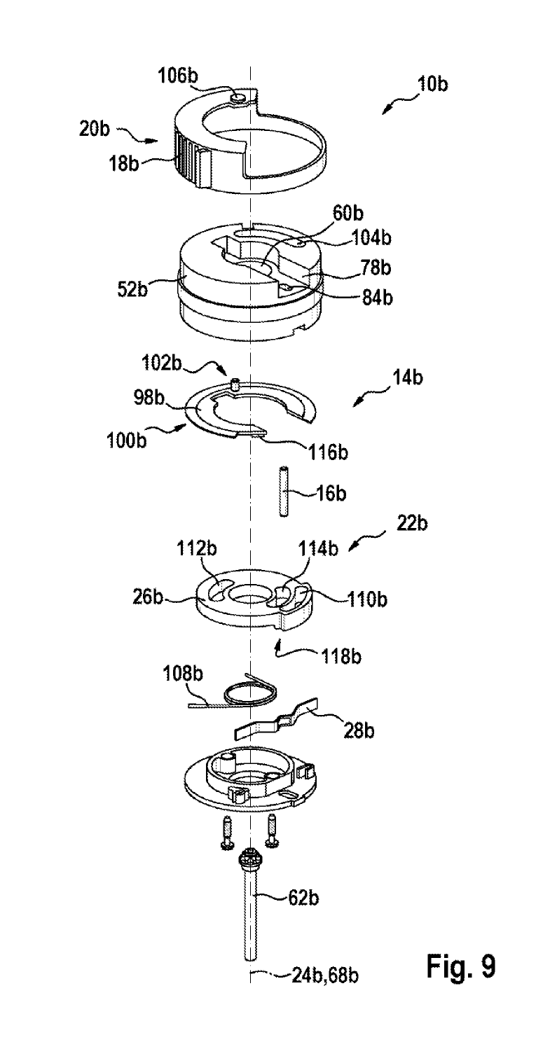

For the purpose of moving the clamping element 98b as a result of an actuation of the operating element 18b, in particular as a result of a rotation of the operating element 18b, the clamping element 98b comprises a stud-type actuating region 102b (FIG. 9). When the clamping element 98b is in a mounted state, the actuating region 102b is disposed in a movement guide recess 104b of the main body 52b, which movement guide recess is in the shape of a circular-ring segment (FIG. 9). The operating element 18b has a movement transmission element 106b, which is provided to receive the actuating region 102b of the clamping element 98b. The movement transmission element 106b is realized as a cup-shaped hollow, which is realized so as to correspond to the stud-type actuating region 102b of the clamping element 98b. It is also conceivable, however, for the movement transmission element 106b to be of another design, considered appropriate by persons skilled in the art, such as, for example, designed as a circular through-hole, etc.

Furthermore, the cutting-strand tensioning unit 14b comprises at least one transmission unit 22b, which is provided to move the tensioning element 16b as a result of an actuation of the operating element 18b of the operating unit 20b. The tensioning element 16b in this case is mounted in a translationally movable manner in a guide recess 84b of the main body 52b of the tool coupling device 10b. The transmission unit 22b has at least one gate element 26b for moving the tensioning element 16b as a result of an actuation of the operating element 18b. The gate element 26b in this case is mounted in a rotatable manner. Moreover, the gate element 26b is realized as a gate disk, which has at least one tensioning-element guide gate 110b and at least two gate-element guide recesses 112b, 114b (FIG. 9). In this case, the tensioning element 16b, when in a mounted state, is disposed in the tensioning-element guide gate 110b. The tensioning-element guide gate 110b in this case has a spiral course in relation to the rotation axis 68b of the drive element 62b. In addition, the cutting-strand tensioning unit 14b comprises at least one spring element 28b, which is provided to apply a spring force to the tensioning element 16b (FIGS. 8 and 9). The spring element 28b is realized as a spring plate, which applies a spring force to the tensioning element 16b in the direction of a tensioning position of the tensioning element 16b. The cutting-strand tensioning unit 14b additionally comprises at least one further spring element 108b, which is provided to apply a spring force to the gate element 26b of the transmission unit 22b (FIGS. 8 and 9). The further spring element 108b is realized as a leg spring. The further spring element 108b in this case is supported with one end on the main body 52b and, with another end, the further spring element 108b is supported on the gate element 26b.

The gate element 26b is moved against the spring force of the further spring element 108b by means of the clamping element 98b, or by means of a rotational movement of the operating element 18b, via the clamping element 98b. For this purpose, the clamping element 98b has a driving extension 116b, which extends in the direction of the gate element 26b. The driving extension 116b acts in combination with a movement driving region 118b of the gate element 26b for the purpose of moving the gate element 26b (FIG. 9). As a result, the gate element 26b is moved, at least in one direction, in dependence on a movement of the clamping element 98b. A movement of the gate element 26b causes the tensioning element 16b to be moved, by means of the tensioning-element guide gate 110b, into a guide-unit insertion position. In addition, the clamping element 98b releases a receiving recess 78b of the main body 52b, for the purpose of receiving the power-tool parting device 12b. The guide recess 84b, in which the tensioning element 16b is guided, is disposed in the region of the receiving recess 78b on the main body 52b.

After the receiving recess 78b has been released and the clamping element 16b has moved into the guide-unit insertion position, the power-tool parting device 12b can be introduced into the receiving recess 78b, along a direction that is at least substantially parallel to the rotation axis 68b of the drive element 62b. A rotational movement of the operating element 18b then causes the clamping element 98b to be moved into a clamping position, causing a clamping force to be exerted upon the power-tool parting device 12b in the direction of the main body 52b. In addition, the gate element 26b is turned as a result of the spring force of the further spring element 108b, and the tensioning element 16b is moved translationally in the guide recess 84b by means of the tensioning-element guide gate 110b. As a result, a guide unit 42b of the power-tool parting device 12b is moved relative to the drive element 62b. This results in tensioning of a cutting strand 40b of the power-tool parting device 12b by the spring force of the spring element 28b and of the further spring element 108b, or by the movement of the tensioning element 16b. Thus, automatic tensioning of the cutting strand 40b is effected as a result of the power-tool parting device 12b being clamped in the receiving recess 78b of the main body 52b. The tensioning-element guide gate 110b in this case is realized in such a manner that, by means of the tensioning-element guide gate 110b acting in combination with the spring element 28b and the further spring element 108b, a movement of the tensioning element 16b into a guide-unit insertion position is effected in a self-locking manner. Moreover, the further spring element 108b acts, via the gate element 26b, upon the clamping element 98b, which, in turn, acts upon the operating element 18b. As a result, the spring force of the further spring element 108b forces the clamping element 98b into the clamping position. It is also conceivable, however, for the clamping element 98b, or the operating element 18b, to be mounted in isolation from the spring force, and to be held in the clamping position by means of a fixing unit of the tool coupling device 10b.

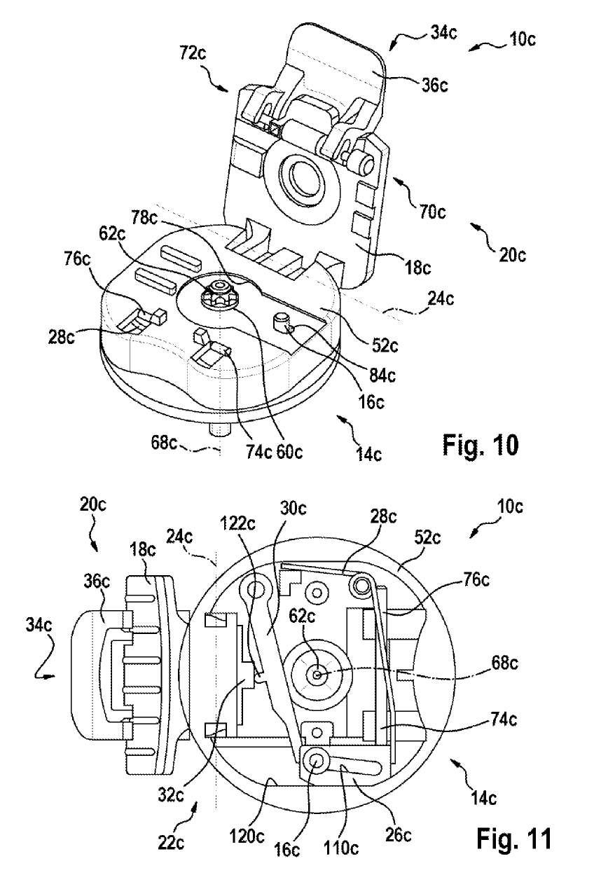

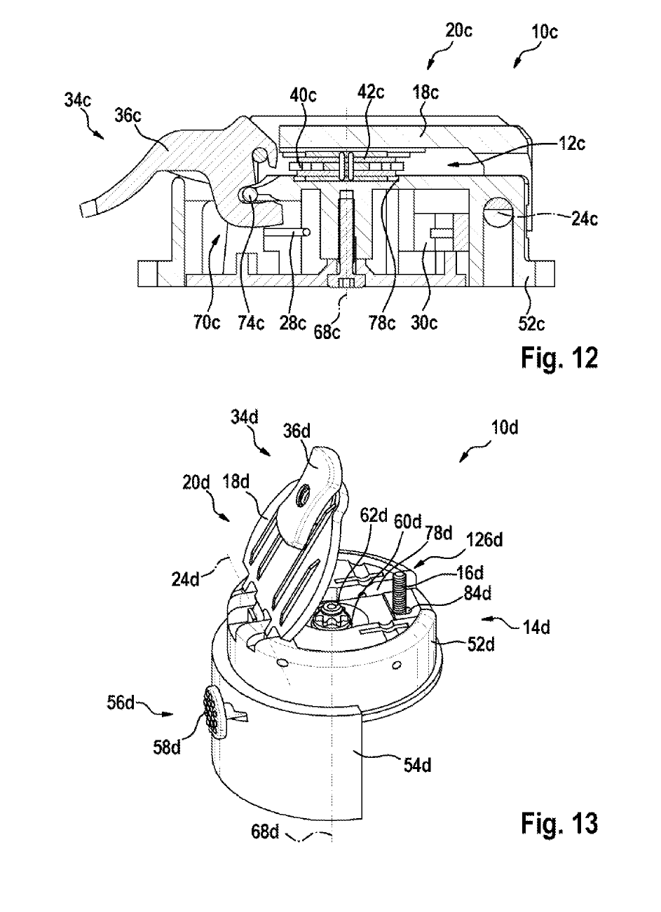

FIG. 10 shows a further, alternative tool coupling device 10c, which is provided to receive a power-tool parting device 12c realized as a closed system (FIG. 12), demounted from a portable power tool (not represented in greater detail here). The portable power tool is of a design similar to that of the portable power tool 38a described in FIGS. 1 to 6. The portable power tool and the power-tool parting device 12c together form a power tool system. The tool coupling device 10c has at least one cutting-strand tensioning unit 14c, which comprises at least one tensioning element 16c, and at least one operating unit 20c that comprises at least one operating element 18c. The operating element 18c is mounted such that it can be swiveled about an axis of motion 24c of the operating element 18c that is at least substantially parallel to a plane of main extent of the operating element 18c, or about one that is at least substantially perpendicular to a rotation axis 68c of a drive element 62c of the tool coupling device 10c.

The cutting-strand tensioning unit 14c additionally comprises at least one transmission unit 22c, which is provided to move the tensioning element 16c as a result of an actuation of the operating element 18c of the operating unit 20c. The transmission unit 22c has at least one gate element 26c for moving the tensioning element 16c as a result of an actuation of the operating element 18c. The gate element 26c is mounted in a translationally movable manner. The gate element 26c in this case is guided in an axial bearing recess 120c of a main body 52c of the tool coupling device 10c (FIG. 11). The gate element 26c comprises a tensioning-element guide gate 110c for moving the tensioning element 16c. The tensioning-element guide gate 110c extends at least substantially transversely in relation to an axis of motion of the gate element 26c. The tensioning-element guide gate 110c is thus sloped relative to the axis of motion of the gate element 26c.

Moreover, the transmission unit 22c comprises at least one lever element 30c that, as a result of an actuation of the operating element 18c, moves the gate element 26c of the transmission unit 22c for the purpose of moving the tensioning element 16c. The lever element 30c is mounted in the main body 52c so as to be rotatable about an axis of motion of the lever element 30c that is at least substantially parallel to the rotation axis 68c of the drive element 62c. For the purpose of moving the gate element 26c, the lever element 30c bears with one end against the gate element 26c. In addition, the lever element 30c has an actuating extension 122c, which acts in combination with the operating element 18c. Furthermore, the cutting-strand tensioning unit 14c comprises at least one spring element 28c, which is provided to apply a spring force to the tensioning element 16c and/or to the gate element 26c of the transmission unit 22c. The spring element 28c is realized as a leg spring. The spring element 28c in this case is supported with one end on the main body 52c and, with another end, the spring element 28c is supported on the gate element 26c. The tool coupling device 10c additionally has at least one fixing unit 34c, comprising at least one fixing element 36c provided to fix the operating element 18c in at least one position. The fixing unit 34c is of a design similar to that of the fixing unit 34a described in FIGS. 1 to 6. The fixing element 36c thus fixes the operating element 18c in a tool fixing position of the operating element 18c (FIG. 12).

For the purpose of coupling the power-tool parting device 12c to the tool coupling device 10c, the power-tool parting device 12c is inserted in a receiving recess 78c of the main body 52c, along a direction that is at least substantially parallel to the rotation axis 68c of the drive element 62c. The operating element 18c in this case is disposed in the position in which it has been swiveled away from the main body 52c. As the power-tool parting device 12c is inserted in the receiving recess 78c, the drive element 62c is introduced into a coupling recess 94c of a guide unit 42c of the power-tool parting device 12c. As a result, a cutting strand 40c of the power-tool parting device 12c engages with the drive element 62c. In addition, the tensioning element 16c is introduced into a tensioning recess 86c of the guide unit 42c. As a result of the operating element 18c being moved into the tool fixing position, the operating element 18c actuates the lever element 30c by means of an eccentric element 32c of the transmission unit 22c. As a result, the lever element 30c is swiveled about the axis of motion of the lever element 30c, and actuates the gate element 26c. The gate element 26c in this case is moved translationally. The tensioning element 16c is thus moved into a guide-unit insertion position by the tensioning-element guide gate 110c. In respect of further features of the tool coupling device 10c, reference may be made to the description of FIGS. 1 to 6.

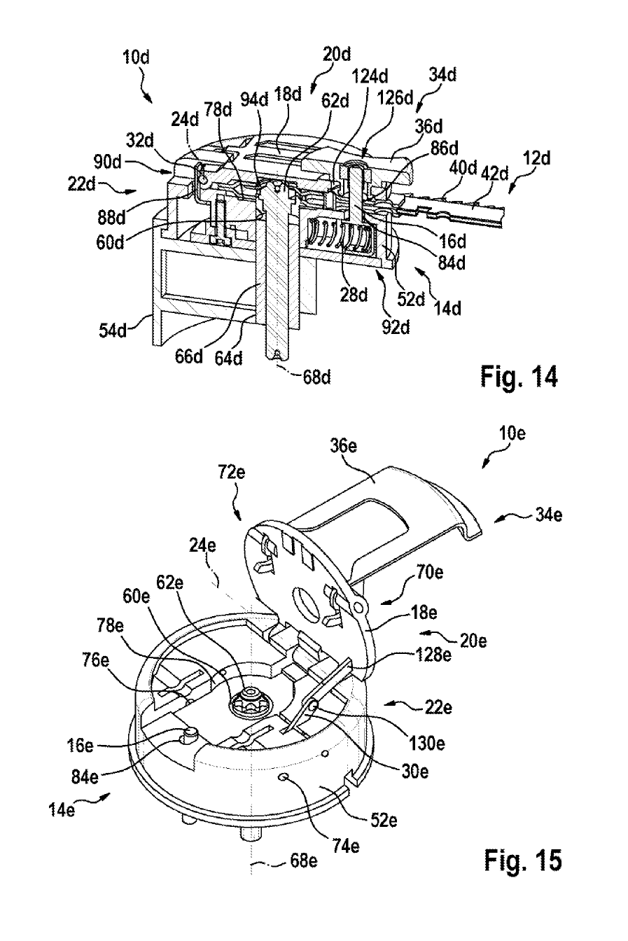

FIG. 13 shows a further, alternative tool coupling device 10d, which is provided to receive a power-tool parting device 12d realized as a closed system (FIG. 14), demounted from a portable power tool (not represented in greater detail here). The portable power tool is of a design similar to that of the portable power tool 38a described in FIGS. 1 to 6. The portable power tool and the power-tool parting device 12d together form a power tool system. The tool coupling device 10d has at least one cutting-strand tensioning unit 14d, which comprises at least one tensioning element 16d, and at least one operating unit 20d that comprises at least one operating element 18d. The operating element 18d is mounted such that it can be swiveled about an axis of motion 24d of the operating element 18d that is at least substantially parallel to a plane of main extent of the operating element 18d, or about one that is at least substantially perpendicular to a rotation axis 68d of a drive element 62d of the tool coupling device 10d.

The cutting-strand tensioning unit 14d comprises at least one transmission unit 22d, which is provided to move the tensioning element 16d as a result of an actuation of the operating element 18d of the operating unit 20d. The transmission unit 22d is of a design similar to that of the transmission unit 22a described in FIGS. 1 to 6. Furthermore, the tool coupling device 10d has at least one fixing unit 34d, comprising at least one fixing element 36d provided to fix the operating element 18d in at least one position. The fixing element 36d in this case is realized as a wing nut. Moreover, the fixing element 36d is mounted in a rotationally and translationally movable manner in a fixing recess 124d of the operating element 18d (FIG. 14). For the purpose of fixing the operating element 18d, the fixing element 36d acts in combination with a threaded region 126d of the tensioning element 16d. When the operating element 18d is moved into a tool fixing position of the operating element 18d, the fixing element 36d and the threaded region 126d of the tensioning element 16d are connected to each other. Since the fixing element 36d is disposed in the fixing recess 124d, the tensioning element 16d can move translationally together with the fixing element 36d. In respect of further features of the tool coupling device 10d, reference may be made to the description of FIGS. 1 to 6.

FIG. 15 shows a further, alternative tool coupling device 10e, which is provided to receive a power-tool parting device realized as a closed system (not represented in greater detail here), demounted from a portable power tool (not represented in greater detail here). The portable power tool is of a design similar to that of the portable power tool 38a described in FIGS. 1 to 6. The portable power tool and the power-tool parting device together form a power tool system. The tool coupling device 10e has at least one cutting-strand tensioning unit 14e, which comprises at least one tensioning element 16e, and at least one operating unit 20e that comprises at least one operating element 18e. The operating element 18e is mounted such that it can be swiveled about an axis of motion 24e of the operating element 18e that is at least substantially parallel to a plane of main extent of the operating element 18e, or about one that is at least substantially perpendicular to a rotation axis 68e of a drive element 62e of the tool coupling device 10e.

The cutting-strand tensioning unit 14e additionally comprises at least one transmission unit 22e, which is provided to move the tensioning element 16e as a result of an actuation of the operating element 18e of the operating unit 20e. The transmission unit 22e has at least one gate element 26e for moving the tensioning element 16e as a result of an actuation of the operating element 18e. The gate element 26e is mounted in a rotatable manner. The gate element 26e in this case is mounted in a rotatable manner in a main body 52e of the tool coupling device 10e. The gate element 26e additionally has at least one tensioning-element guide gate 110e for moving the tensioning element 16e as a result of an actuation of the operating element 18e. The transmission unit 22e additionally comprises at least one lever element 30e that, as a result of an actuation of the operating element 18e, moves the gate element 26e of the transmission unit 22e for the purpose of moving the tensioning element 16e. The lever element 30e in this case is mounted in the main body 52e such that it can be swiveled about an axis of motion of the lever element 30e. The axis of motion of the lever element 30e in this case is at least substantially parallel to the axis of motion 24e of the operating element 18e. Moreover, the transmission unit 22e has a force transfer element 128e, which is mounted in a swiveling manner on the operating element 18e. In addition, the force transfer element 128e is connected in a swiveling manner to the lever element 30e, by means of a link element 130e. The link element 130e in this case is realized as a hinge pin, which engages in a link eye of the lever element 30e and of the force transfer element 128e, respectively.

Furthermore, the cutting-strand tensioning unit 14e comprises at least one spring element 28e, which is provided to apply a spring force to the tensioning element 16e and/or to the gate element 26e of the transmission unit 22e. The spring element 28e is realized as a leg spring. The spring element 28e in this case is supported with one end on the main body 52e and, with another end, the spring element 28e is supported on the gate element 26e. As a result of the operating element 18e moving into a tool fixing position of the operating element 18e, in the direction of the main body 52e, the lever element 30e is actuated by means of the force transfer element 128e. As a result, the lever element 30e releases the gate element 26e. The gate element 26e is moved by the spring force of the spring element 28e. As a result, the tensioning element 16e is moved into a tensioning position of the tensioning element 16e by means of the tensioning-element guide gate 110e. In respect of further features of the tool coupling device 10e, reference may be made to the description of FIGS. 1 to 6.

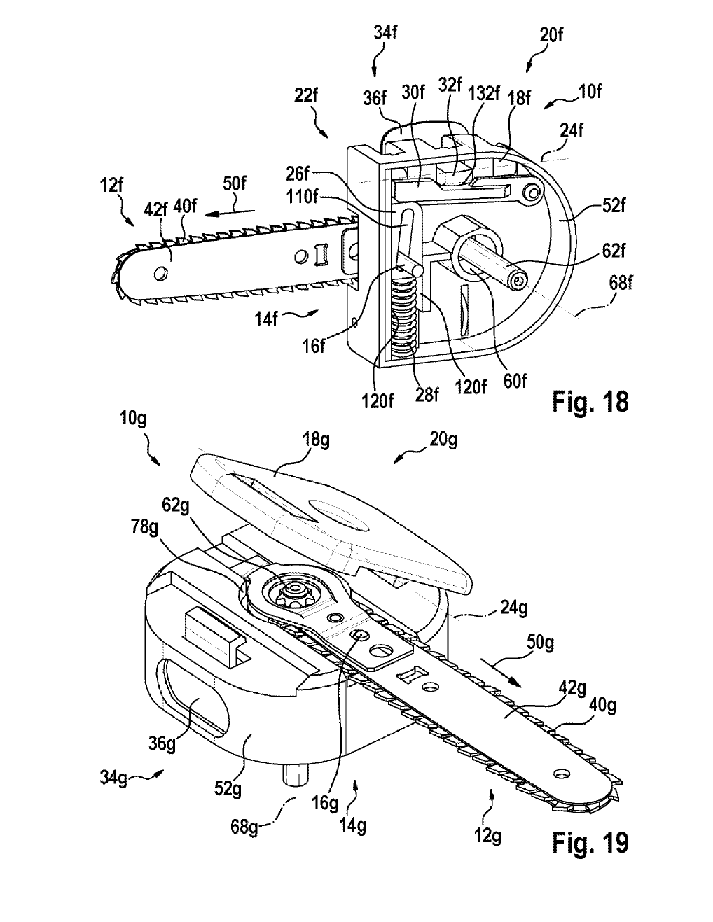

FIG. 17 shows a further, alternative tool coupling device 10f, which is provided to receive a power-tool parting device 12f realized as a closed system (FIG. 18), demounted from a portable power tool (not represented in greater detail here). The portable power tool is of a design similar to that of the portable power tool 38a described in FIGS. 1 to 6. The portable power tool and the power-tool parting device 12f together form a power tool system. The tool coupling device 10f has at least one cutting-strand tensioning unit 14f, which comprises at least one tensioning element 16f, and at least one operating unit 20f that comprises at least one operating element 18f. The operating element 18f is mounted such that it can be swiveled about an axis of motion 24f of the operating element 18f that is at least substantially parallel to a plane of main extent of the operating element 18f, or about one that is at least substantially perpendicular to a rotation axis 68f of a drive element 62f of the tool coupling device 10f.

The cutting-strand tensioning unit 14f additionally comprises at least one transmission unit 22f, which is provided to move the tensioning element 16f as a result of an actuation of the operating element 18f of the operating unit 20f. The transmission unit 22f has at least one gate element 26f for moving the tensioning element 16f as a result of an actuation of the operating element 18f. The gate element 26f is mounted in a translationally movable manner. In this case, the gate element 26f is guided in an axial bearing recess 120f of a main body 52f of the tool coupling device 10f (FIG. 18). The gate element 26f comprises a tensioning-element guide gate 110f, for moving the tensioning element 16f. The tensioning-element guide gate 110f extends at least substantially transversely in relation to an axis of motion of the gate element 26f. The tensioning-element guide gate 110f is thus sloped relative to the axis of motion of the gate element 26f.

The transmission unit 22f additionally comprises at least one lever element 30f that, as a result of an actuation of the operating element 18f, moves the gate element 26f of the transmission unit 22f for the purpose of moving the tensioning element 16f. The lever element 30f is mounted in the main body 52f so as to be rotatable about an axis of motion of the lever element 30f that is at least substantially parallel to the rotation axis 68f of the drive element 62f. For the purpose of moving the gate element 26f, the lever element 30f bears with one end against the gate element 26f. In addition, the lever element 30f has an operating-element pressure region 132f, which acts in combination with the operating element 18f. Furthermore, the cutting-strand tensioning unit 14f comprises at least one spring element 28f, which is provided to apply a spring force to the clamping element 16f and/or to the gate element 26f of the transmission unit 22f. The spring element 28f is realized as a helical compression spring. The spring element 28f in this case is supported with one end on the main body 52f and, with another end, the spring element 28f is supported on the gate element 26f. The spring element 28f is disposed in the axial bearing recess 120f of the main body 52f. In respect of further features of the tool coupling device 10f, reference may be made to the description of FIGS. 1 to 6.

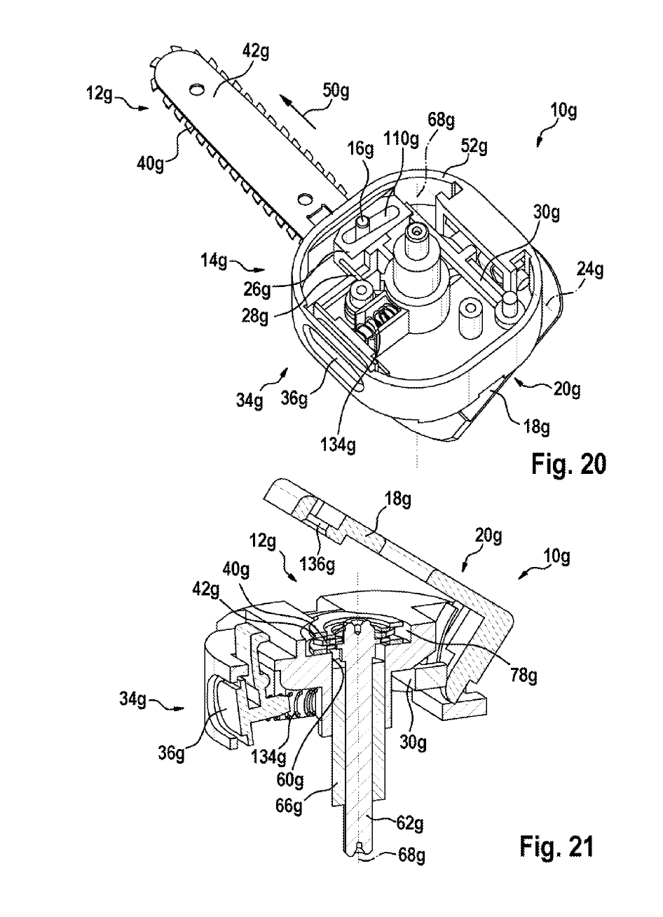

FIG. 19 shows a further, alternative tool coupling device 10g, which is provided to receive a power-tool parting device 12g realized as a closed system, demounted from a portable power tool (not represented in greater detail here). The portable power tool is of a design similar to that of the portable power tool 38a described in FIGS. 1 to 6. The portable power tool and the power-tool parting device 12g together form a power tool system. The design of the tool coupling device 10g is at least substantially similar to that of the tool coupling device 10f described in FIGS. 17 and 18. Unlike the tool coupling device 10f, a cutting-strand tensioning unit 14g of the tool coupling device 10g has a spring element 28g realized as a leg spring. In addition, the tool coupling device 10g has at least one fixing unit 34g, comprising at least one fixing element 36g provided to fix the operating element 18g in at least one position. The fixing element 36g is mounted in a swiveling manner in a main body 52g of the tool coupling device 10g (FIG. 21). The fixing unit 34g additionally has a fixing spring element 134g, which is provided to apply a spring force to the fixing element 36g (FIGS. 20 and 21). The fixing element 36g is thus realized as a spring-biased latching hook, which acts in combination with a fixing extension 136g disposed in the operating element 18g, for the purpose of fixing the operating element 18g in a tool fixing position (FIG. 21). The fixing extension 136g in this case is realized so as to be integral with the operating element 18g.

FIGS. 22 to 31 show alternative holding units of a tool coupling device, which are provided to apply a clamping force in the direction of a main body of the tool coupling device. Components, features and functions that remain substantially the same are denoted basically by the same references. To differentiate the exemplary embodiments, superscript numerals have been appended, in addition to the letters, to the references of the exemplary embodiments. The following description is limited substantially to the differences as compared with the first exemplary embodiment in FIGS. 1 to 6, and reference may be made to the description of the first exemplary embodiment in FIGS. 1 to 6 in respect of components, features and functions that remain the same.

FIG. 22 shows a holding unit of a tool coupling device 10a¹. The holding unit has at least one screw connection element, which acts in combination with a threaded recess (not represented in greater detail here) disposed on the main body 52a¹, for the purpose of generating a clamping force, or holding force, in the direction of a main body 52a¹ of the tool coupling device 10a¹.

FIG. 23 shows a holding unit of a tool coupling device 10a². The holding unit has at least two hook elements, aligned in opposing directions, which can be inserted in recesses of a power-tool parting device 12a² for the purpose of generating a clamping force, or holding force, in the direction of a main body 52a¹ of the tool coupling device 10a¹ and which, following insertion, are moved in opposing directions as a result of a spring force.

FIG. 24 shows a holding unit of a tool coupling device 10a³. The holding unit has at least one stirrup element, which delimits a recess into which a power-tool parting device 12a³ can be introduced, at least substantially perpendicularly in relation to an active holding force.

FIG. 25 shows an alternative holding unit of a tool coupling device 10a⁴. The holding unit has at least one toggle mechanism unit, which is provided to generate a clamping force, or holding force, in the direction of a main body 52a⁴ of the tool coupling device 10a⁴.

FIG. 26 shows an alternative holding unit of a tool coupling device 10a⁵. The holding unit has at least one spring-loaded latching hook, which acts in combination with a recess of a power-tool parting device 12a⁵, for the purpose of generating a clamping force, or holding force, in the direction of a main body 52a⁵ of the tool coupling device 10a⁵.

FIG. 27 shows an alternative holding unit of a tool coupling device 10a⁶. The holding unit has at least one transverse slide element that, after a power-tool parting device 12a⁶ has been inserted in a receiving recess 78a⁶ of a main body 52a⁶ of the tool coupling device 10a⁶, is mounted so as to be displaceable over the power-tool parting device 12a⁶, at least substantially transversely in relation to an insertion direction of the power-tool parting device 12a⁶.

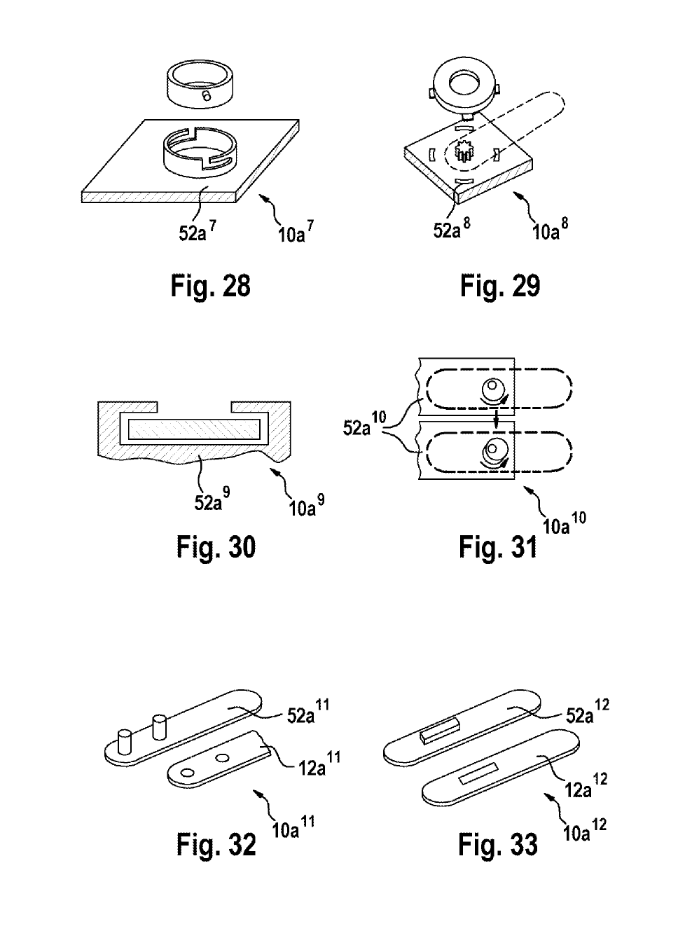

FIG. 28 shows an alternative holding unit of a tool coupling device 10a⁷. The holding unit has at least one bayonet locking element, which acts in combination with a bayonet locking element of a power-tool parting device 12a⁷, for the purpose of generating a clamping force, or holding force, in the direction of a main body 52a⁷ of the tool coupling device 10a⁷.

FIG. 29 shows an alternative holding unit of a tool coupling device 10a⁸. The holding unit has at least one holding axle, which acts in combination with a holding-lug engagement-extension cover element of the holding unit at least one, for the purpose of generating a clamping force, or holding force, in the direction of a main body 52a⁸ of the tool coupling device 10a⁸.

FIG. 30 shows an alternative holding unit of a tool coupling device 10a⁹. The holding unit has at least one C-shaped form-closure holding element, which can be inserted in a power-tool parting device 12a⁹.

FIG. 31 shows an alternative holding unit of a tool coupling device 10a¹⁰. The holding unit has at least one eccentric element, which acts in combination with a circular recess of a power-tool parting device 12a¹⁰, for the purpose of generating a clamping force, or holding force, in the direction of a main body 52a¹⁰ of the tool coupling device 10a¹⁰.

FIGS. 32 to 35 show alternative power-tool parting-device torque holding units of a tool coupling device, which are provided to secure the power-tool parting device against a rotational movement when the power-tool parting device is coupled to the tool coupling device. Components, features and functions that remain substantially the same are denoted basically by the same references. To differentiate the exemplary embodiments, superscript numerals have been appended, in addition to the letters, to the references of the exemplary embodiments. The following description is limited substantially to the differences as compared with the first exemplary embodiment in FIGS. 1 to 6, and reference may be made to the description of the first exemplary embodiment in FIGS. 1 to 6 in respect of components, features and functions that remain the same.

FIG. 32 shows an alternative power-tool parting-device torque holding unit of a tool coupling device 10a¹¹. The power-tool parting-device torque holding unit has at least two stud-type torque holding elements, which can be inserted in corresponding recesses of a power-tool parting device 12a¹¹. It is also conceivable, however, for the power-tool parting-device torque holding unit to have at least two recesses, in each of which a respective stud-type torque holding element of the power-tool parting device 12a¹¹ can be inserted.

FIG. 33 shows an alternative power-tool parting-device torque holding unit of a tool coupling device 10a¹². The power-tool parting-device torque holding unit has at least one rectangular torque holding extension, which can be inserted in at least one rectangular recess of a power-tool parting device 12a¹². It is also conceivable, however, for the power-tool parting-device torque holding unit to have at least one rectangular recess, in which the rectangular torque holding element of the power-tool parting device 12a¹² can be inserted.

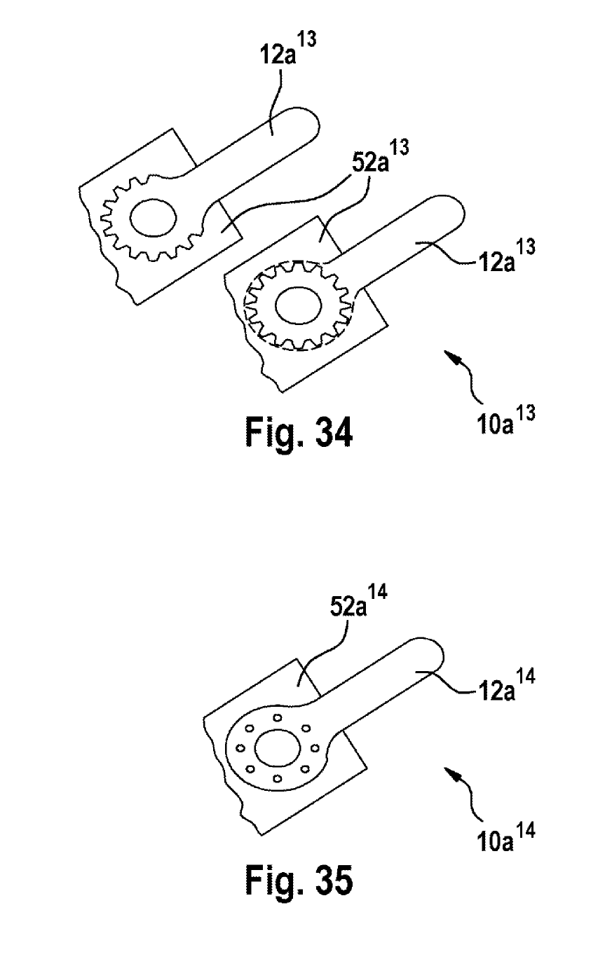

FIG. 34 shows an alternative power-tool parting-device torque holding unit of a tool coupling device 10a¹³. The power-tool parting-device torque holding unit has at least one tooth system (external tooth system, internal tooth system or end-face tooth system), which acts in combination with a corresponding tooth system of a power-tool parting device 12a¹³.

FIG. 35 shows an alternative power-tool parting-device torque holding unit of a tool coupling device 10a¹⁴. The power-tool parting-device torque holding unit has at least a multiplicity of form-closure elements, disposed symmetrically around a rotation axis 68a¹⁴ of a drive element 62a¹⁴, which act in combination with symmetrically disposed form-closure elements of a power-tool parting device 12a¹⁴.

1. A tool coupling device for receiving a power-tool parting device realized as a closed system, comprising:
at least one cutting-strand tensioning unit that has at least one tensioning element; and
at least one operating unit including at least one operating element,
wherein the cutting-strand tensioning unit comprises at least one transmission unit configured to move the tensioning element as a result of an actuation of the operating element of the operating unit.

2. The tool coupling device as claimed in claim 1, wherein the operating element is mounted such that the operating element is configured to be swiveled about an axis of motion of the operating element that is at least substantially parallel to a plane of main extent of the operating element.

3. The tool coupling device as claimed at least in claim 1, wherein the operating element is mounted such that the operating element is configured to rotate about an axis of motion of the operating element that is at least substantially perpendicular to a plane of main extent of the operating element.

4. The tool coupling device as claimed in claim 1, wherein the tensioning element is mounted in a translationally movable manner.

5. The tool coupling device as claimed in claim 1, wherein the transmission unit has at least one gate element configured to move the tensioning element as a result of an actuation of the operating element.

6. The tool coupling device as claimed in claim 5, wherein the gate element is mounted in a translationally movable manner.

7. The tool coupling device at least as claimed in claim 5, wherein the gate element is mounted in a rotatable manner.

8. The tool coupling device as claimed in claim 1, wherein the cutting-strand tensioning unit has at least one spring element, that is configured to apply a spring force to one or more of the tensioning element and a gate element of the transmission unit.

9. The tool coupling device as claimed in claim 1, wherein the transmission unit comprises at least one lever element that, as a result of an actuation of the operating element, moves a gate element of the transmission unit to move the tensioning element.

10. The tool coupling device as claimed in claim 1, wherein the transmission unit comprises at least one eccentric element that acts in combination with the tensioning element to move the tensioning element as a result of an actuation of the operating element.

11. The tool coupling device as claimed in claim 1, further comprising at least one fixing unit including at least one fixing element configured to fix the operating element in at least one position.

12. The tool coupling device as claimed in claim 11, wherein the fixing element is mounted in a swiveling manner.

13. A portable power tool, comprising:
a tool coupling device including:
at least one cutting-strand tensioning unit that has at least one tensioning element; and
at least one operating unit including at least one operating element,
wherein the cutting-strand tensioning unit comprises at least one transmission unit configured to move the tensioning element as a result of an actuation of the operating element of the operating unit.

14. A power tool system, comprising:
at least one portable power tool including a tool coupling device, the tool coupling device including:
at least one cutting-strand tensioning unit that has at least one tensioning element; and
at least one operating unit including at least one operating element,
wherein the cutting-strand tensioning unit comprises at least one transmission unit configured to move the tensioning element as a result of an actuation of the operating element of the operating unit; and
at least one power-tool parting device having at least one cutting strand and at least one guide unit that, together with the cutting strand, forms a closed system.
